(19) United States
(12) Patent Application Publication
(10) Pub. No.: US 2025/0217683 A1
(43) Pub. Date: Jul. 3, 2025

(54) Copy-Or-Generate Model With Semi-Sandboxed Or Fully Sandboxed Decoding To Handle Text Generation Tasks In Accurate And Secure Manner

(71) Applicant: Oracle International Corporation, Redwood Shores, CA (US)

(72) Inventors: Paul Cayet, Zurich (CH); Rhicheek Patra, Zurich (CH); Damien Hilloulin, Zurich (CH); Sungpack Hong, Palo Alto, CA (US); Hassan Chafi, Zurich (CH)

(21) Appl. No.: 18/400,130

(22) Filed: Dec. 29, 2023

(51) Int. Cl. G06N 7/01; G06N 20/00

(52) U.S. Cl. CPC G06N 7/01; G06N 20/00

(57) ABSTRACT

A copy-or-generate model architecture is provided that a generates generation distribution obtained from the outputs of the last decoder layer and a copy distribution built from the cross-attention scores of the last decoder layer. The model applies copy weights to the generation distribution and copy distribution to determine whether to generate a next token or to copy a token from the prompt. The model provides better security by ensuring that the input values from the prompt are directly copied to the output when appropriate, such that the model is blind to the original values to copy. In a semi-sandboxed configuration, additional information may be input to the model to help the model adapt the output based on the context of those input fields.

### FIELD OF THE INVENTION

The present invention relates to a machine learning model architecture and optimized training and inference methodologies for performing text generation given structured prompts. More specifically, the optimized training and inference methodologies include a copy-or-generate model architecture along with context compression and embedding aggregation techniques that enable improved generalization while protecting the training/inference data.

### BACKGROUND

From the first Neural Machine Translation (NMT) models to the more recent Large Language Models (LLMs) (e.g., OpenAI), various neural language models have been developed to perform sequence-to-sequence modeling. In particular, LLMs trained on trillions of tokens have showcased remarkable performance on prompt-answering tasks. However, these large models present several flaws. For example, large architecture implies slow inference time and cost of running a large model. Furthermore, there are legal issues regarding the data used for training these models. Still further, there are potential security issues due to “prompt attacks” that make models reveal secrets from the training data.

On the other hand, smaller models based on the transformer architecture have been studied for their sentence parsing capabilities. A transformer is a deep learning architecture that relies on the parallel multi-head attention mechanism. These smaller models are unable to generalize to longer input lengths; therefore, larger and more computationally expensive architectures are used in an attempt to increase functionality and performance.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Further, it should not be assumed that any of the approaches described in this section are well-understood, routine, or conventional merely by virtue of their inclusion in this section.

### BRIEF DESCRIPTION OF THE DRAWINGS

In the drawings:

FIG. 1A is a block diagram illustrating an encoder-decoder model performing free generation in accordance with an illustrative embodiment.

FIG. 1B is a block diagram illustrating an encoder-decoder model performing conditional generation in accordance with an illustrative embodiment.

FIG. 1C is a block diagram illustrating an encoder-decoder model performing a copy from the context into the output in accordance with an illustrative embodiment.

FIG. 2 is a block diagram illustrating a copy-or-generate model architecture in accordance with an illustrative embodiment.

FIG. 3 illustrates how the copy distribution is built in accordance with an illustrative embodiment.

FIG. 4 is a flowchart illustrating training of a copy-or-generate model in accordance with an illustrative embodiment.

FIG. 5 illustrating creation and pre-processing of a training dataset in accordance with an illustrative embodiment.

FIG. 6 illustrates context processing and compression in accordance with an illustrative embodiment.

FIG. 7 illustrates target processing in accordance with an illustrative embodiment.

FIG. 8 illustrates embedding aggregation in accordance with an illustrative embodiment.

FIG. 9 is a flowchart illustrating inference using a copy-or-generate model in accordance with an illustrative embodiment.

FIG. 10 is a block diagram that illustrates a computer system upon which aspects of the illustrative embodiments may be implemented.

FIG. 11 is a block diagram of a basic software system that may be employed for controlling the operation of a computer system upon which aspects of the illustrative embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The illustrative embodiments provide an end-to-end machine learning model to perform accurate text generation from prompts with a small but powerful model architecture. The accuracy improvement of the model architecture comes from additional blocks in the architecture helping the model to more easily learn things that are complex for smaller models, such as using variable-length input values. The illustrative embodiments provide a copy-or-generate model architecture that a generates generation distribution obtained from the outputs of the last decoder layer and a copy distribution built from the cross-attention scores of the last decoder layer. The decoder inputs are either the shifted labels (for training) or the beginning of the generated sequence (for inference). The model applies copy weights to the generation distribution and copy distribution to determine whether to generate a next token or to copy a token from the prompt (context). The copy-or-generate model of the illustrative embodiments provides a small model with a faster inference time and lower compute resource cost.

In some embodiments, the model provides better security by ensuring that the input values from the prompt, also referred to as the context, are directly copied to the output when appropriate, such that the model is blind to the original values to copy. This prevents data leaking caused by prompt injection techniques and protects secrecy of the data used for training the models.

In one “adaptive” configuration, referred to as a semi-sandboxed configuration, additional information is input to the model to help the model adapt the output based on the context of those input fields. In an alternative configuration, referred to as a fully sandboxed configuration, the adaptation based on the input values is completely disabled, which enables a full sandboxing of the decoding process, thus providing even stronger security. In the fully sandboxed decoding configuration, context and target processing generate a dual training dataset in which information is only recoverable with the use of compression lookup tables. In the semi-sandboxed configuration, the context and target processing generate additional elements that are used to construct aggregated embeddings, which are compressed representations of the original data. In some embodiments, the embedding aggregation can be customized to allow varying levels of information leaking.

### Model Architecture

The model of the illustrative embodiments is an extension of an encoder-decoder Transformer architecture with an added copy decoder that enables the model to copy tokens from the context to the generated output. The model uses context compression to allow the model to copy multi-token sequences in a single forward pass. In a semi-sandboxed decoding configuration, the embedding aggregation block is also added to support syntactic consistency.

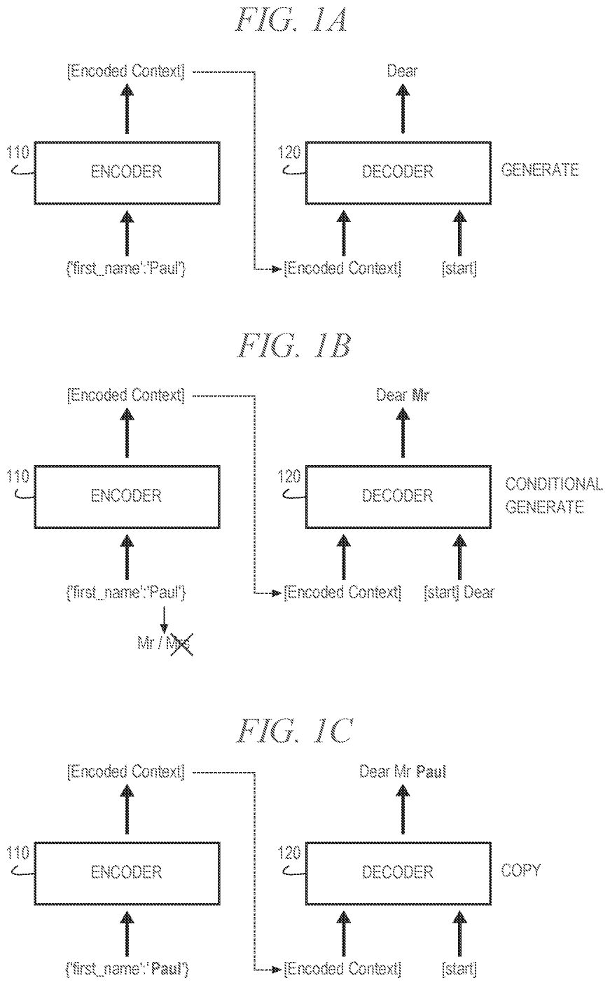

Contrary to a traditional text generation model, the copy-or-generate model of the illustrative embodiments generates two distributes: a classical next-token probability generation distribution and a sparse copy distribution that determines for each element in the context the probability to be copied. A learnable weight determines at each step whether to use the generate or copy distribution for the next token to generate. FIG. 1A is a block diagram illustrating an encoder-decoder model performing free generation in accordance with an illustrative embodiment. In the depicted example, the model generates an acceptance message, such as an email, for a candidate that applied for a job position.

In some embodiments, the context consists of a prompt having attribute-value (or key-value) pairs. In one embodiment, the context is a JavaScript Object Notation (JSON) format. JSON is an open standard file format and data interchange format that uses human-readable text to store and transmit data objects consisting of attribute-value pairs and arrays (or other serializable values). In the example shown in FIG. 1A, the context comprises the following prompt: “{‘first_name’: ‘Paul’},” which indicates the name of the candidate for the job position. The attribute is “first_name” and the value is “Paul.” In practice, the context may include more information, such as last name, job position, etc.

Given the context, encoder 110 generates an encoded context and provides the encoded context to decoder 120. Given the encoded context and an input token, decoder 120 generates a next token, in this case the word “Dear.” In the depicted example, the input token is a start token, which indicates that there are no previous decoder outputs, and the decoder generates a next token of “Dear” as the first word of the acceptance message.

FIG. 1B is a block diagram illustrating an encoder-decoder model performing conditional generation in accordance with an illustrative embodiment. In this case, the next word to be generated will be conditional on at least a portion of the context. More specifically, the next word may be “Mr” or “Mrs” depending on the gender of the job candidate. For simplicity of explanation, the example includes only two genders; however, the model can be trained to any number of genders or to provide conditional generation for more complex conditions. For example, the model can provide condition generation based on a country of residence. In the depicted example, the model is trained to associate the first name “Paul” with “Mr.” Thus, given the encoded context and the input tokens “[start]” and “Dear,” decoder 120 generates a next token of “Mr.”

FIG. 1C is a block diagram illustrating an encoder-decoder model performing a copy from the context into the output in accordance with an illustrative embodiment. In this case, the next word will be copied from the context. More specifically, the next word may be the first name from the context. Encoder 110 provides the encoded context to decoder 120 and generates a sparse copy distribution, which determines for each element in the context the probability that the element is to be copied into the output. Given the encoded context and the input tokens “[start],” “Dear,” and “Mr,” decoder 120 generates a next-token probability generation distribution. A learnable copy weight (in the range of [0, 1]) determines at each step whether to use the generate distribution or the copy distribution for the next token. Note that the encoder generates the copy distribution in FIGS. 1A and 1B, but the copy weight favors the token generated by the decoder. In FIG. 1C, the copy weight favors the copy distribution, which indicates a high probability that the first name is to be copied into the output.

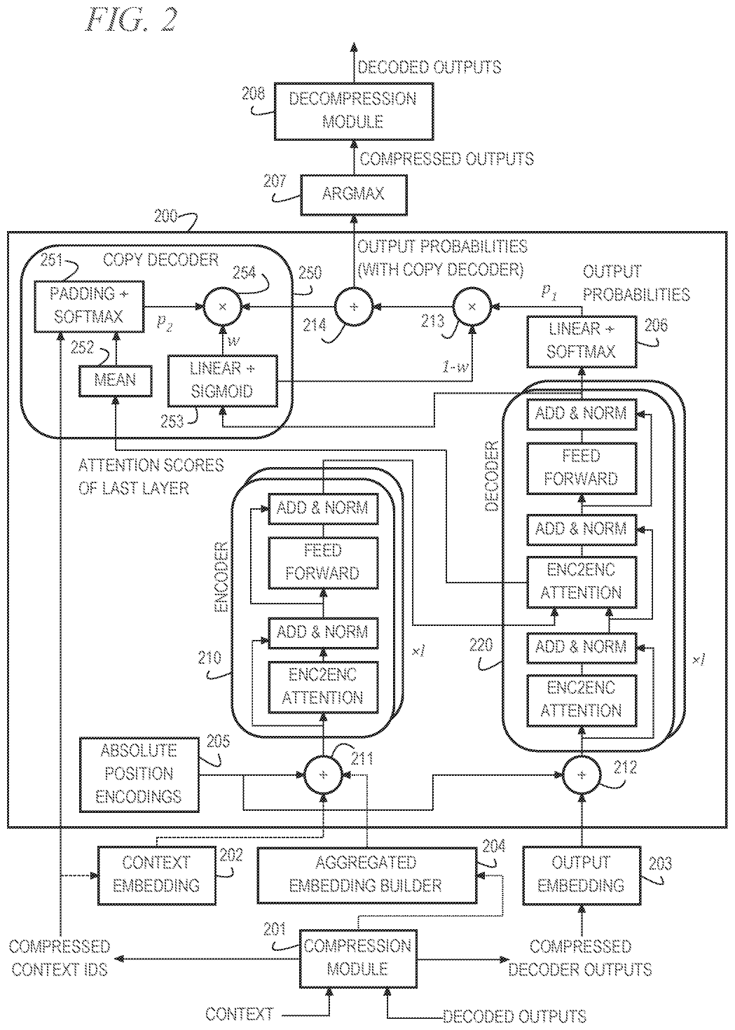

FIG. 2 is a block diagram illustrating a copy-or-generate model architecture in accordance with an illustrative embodiment. The copy-or-generate model architecture is based on the T5 transformer model. A transformer is a deep learning architecture that relies on the parallel multi-head attention mechanism. Input text is encoded as tokens and each token is converted into a vector via looking up from a word embedding table. At each layer, each token is then contextualized within the scope of the context window with other tokens via a parallel multi-head attention mechanism allowing the signal for key tokens to be amplified and less important tokens to be diminished. A transformer model has the following primary components: tokenizers, which convert text into tokens; a single embedding layer, which convert tokens and positions of the tokens into vector representations; transformer layers, which carry out repeated transformations on the vector representations, extracting more and more linguistic information. These consist of alternating attention and feedforward layers; and, an optional un-embedding layer, which converts the final vector representations back to a probability distribution over the tokens. Transformer layers can be one of two types: encoder and decoder. In accordance with the illustrative embodiments, the main components of the model internals 200 of the copy-or-generate model architecture include encoder 210, decoder 220, and copy decoder 250.

In the copy-or-generate model shown in FIG. 2, compression module 201 receives a context and decoded outputs from previous tokens generated by the model. The decoded outputs are either the shifted labels (training) or the beginning of the generated sequence (inference). Compression module 201 generates compressed context identifiers and compressed decoder outputs (previous outputs generated by the copy-or-generate model). The compressed context ids are provided to context embedding module 202, which converts the compressed context ids to embeddings as will be described in further detail below. Context embedding module 202 provides the context embeddings to encoder 210. The compressed decoder outputs are provided to output embedding module 203, which converts the compressed decoder outputs to embeddings as will be described in further detail below. Embedding module 203 provides the decoder output embeddings to decoder 220.

Absolute position encodings 205 provides positional information to the embeddings. A positional encoding is a fixed-size vector representation that encapsulates the relative positions of tokens within a target sequence. It provides the transformer model with information about where the words are in the input sequence. The first encoder takes positional information and embeddings (using element-wise addition function 211) of the input sequence as its input, rather than encodings. The positional information is necessary for the transformer to make use of the order of the sequence. Like the first encoder, the first decoder takes positional information and embeddings (using element-wise addition function 212) of the output sequence as its input, rather than encodings.

The encoder 210 consists of encoding layers (×l) that process the input tokens iteratively one layer after another, while the decoder 220 consists of decoding layers (×l) that iteratively process the encoder's output as well as the decoder output's tokens so far. The number of layers/is configurable and corresponds to a number of parameters. The function of each encoder layer is to generate contextualized token representations, where each representation corresponds to a token that “mixes” information from other input tokens via self-attention mechanism (Enc2Enc Attention). Each decoder layer contains two attention sublayers: (1) cross-attention (Enc2Enc Attention) for incorporating the output of encoder (contextualized input token representations), and (2) self-attention (Enc2Enc Attention) for “mixing” information among the input tokens to the decoder (i.e., the decoded output tokens generated so far during inference time). Both the encoder and decoder layers have a feed-forward neural network for additional processing of the outputs and contain residual connections and layer normalization steps (Add & Norm).

Encoder 210 generates an encoded context and provides the encoded context to the cross-attention sublayer of decoder 220. Each decoder layer consists of three major components: a self-attention mechanism, an attention mechanism over the encodings, and a feed-forward neural network. Decoder 220 functions in a similar fashion to encoder 210, but an additional attention mechanism is inserted, which draws relevant information from the encodings generated by encoder 210. This mechanism can also be called the encoder-decoder attention. Decoder 220 generates an output based on the encoded context provided by encoder 210 and decoder output embeddings provided by output embedding module 203. The output of decoder 220 is provided to linear transformation and softmax layer 206, which generates a probability distribution p₁ over the vocabulary. The softmax function converts a vector of K real numbers into a probability distribution, p₁, of K possible outcomes.

In accordance with an illustrative embodiment, the model internals 200 include a copy decoder 250 in addition to encoder 210 and decoder 220. Copy decoder 250 generates a copy probability distribution p₂ and a copy weight w. The copy-or-generate model then determines whether to directly copy values from the context based on the generation probability distribution p₁, the copy probability distribution p₂, and the copy weight w.

The compressed context ids are provided to padding and softmax layer 251. A mean function 252 averages attention scores generated by the last decoder layer and provides the average attention score to padding and softmax layer 251, which generates the copy probability distribution p₂ over the compressed context ids. The output of decoder 220 is provided to linear transformation and sigmoid layer 253, which generates the copy weight w.

The model performs a scalar×matrix multiplication function 254 of the weight w and the copy probability distribution p2 and performs a scalar×matrix multiplication function 213 of (1-w) and the generation probability distribution p1. The model then performs an element-wise addition function 214 of the results of the two scalar×matrix multiplication functions to generate output probabilities including generation probabilities and copy probabilities. The model then performs an argmax function 207 to determine the maximum probability and provide compressed outputs. Decompression module 208 converts the compressed outputs to decoded outputs.

The above configuration is a fully sandboxed configuration in which context embedding module 202 provides a compressed and private context using bidirectional lookup tables that are not shared with the model. The lookup tables are also used by decompression module 208 for decoding after the generation. With this method, the model is fully blind to the original data in the context, which prevents nay leaking caused by prompt injection techniques. Prompt injection is a vulnerability in Large Language Models (LLMs) where attackers use carefully crafted prompts to make the model ignore its original instructions or perform unintended actions. This can lead to unauthorized access, data breaches, or manipulation of the model's responses. Thus, the fully sandboxed configuration generally does not pass any meaning to the model as it may be used to recover information from the training data.

In accordance with one embodiment, in a semi-sandboxed configuration, aggregated embedding builder 204 builds aggregated embeddings to provide a portion of the context information to the model. The additional information may help the model adapt the output based on the content of input fields in the context. For example, in the conditional generation shown in FIG. 1B, some additional elements of the context, such as the name Paul or a value associated with a gender attribute, would help the model to conditionally generate the next word more accurately. In the model architecture shown in FIG. 2, the aggregated embeddings are added to the context embeddings using clement-wise addition function 211. This provides additional elements to encoder 210, thus providing more information in the encoded context that is provided to decoder 220.

### Copy Distribution

The copy decoder generates the copy distribution directly from the cross-attention scores. This is in contrast to prior solutions that require the use of additional attention layers, which increases the parameter count and hinders the performance. In the illustrative embodiments, the copy decoder uses the attention scores averaged across the attention heads as the copy distribution, which requires no additional parameters.

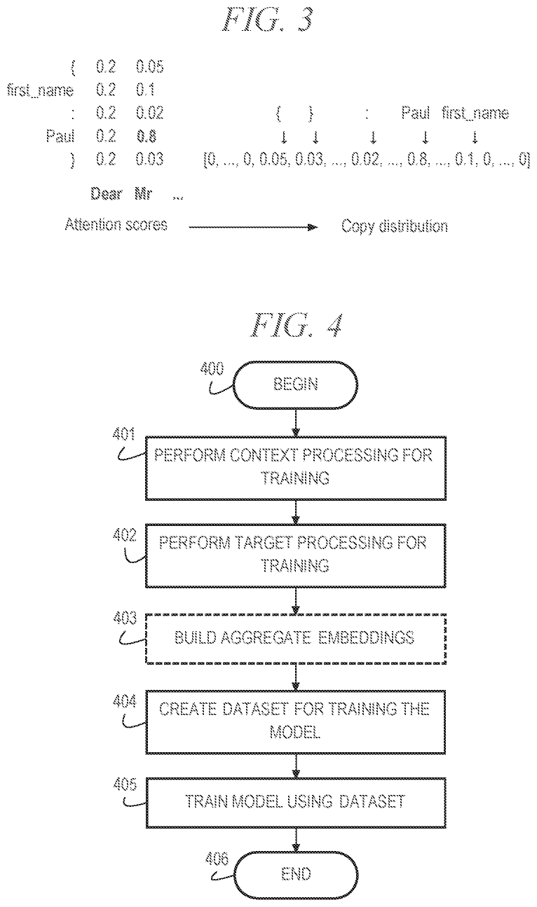

FIG. 3 illustrates how the copy distribution is built in accordance with an illustrative embodiment. Using the task shown in FIGS. 1A-1C, when the last generated token is “Mr,” the attention scores are higher for the token “Paul.” The attention scores are directly converted to a copy distribution by giving a null probability to all the other tokens in the vocabular except the ones from the context, e.g., “{,” “},” “first_name,” “:,” and “Paul” in FIG. 3. The copy distribution is averaged with the generation distribution by using the copy weight as follows:

$$final distribution = ( 1 - copyweight ) \times generation distribution + copyweight \times copy distribution ,$$

where the “^{×}” operator is the scalar^{×} matrix multiplication function 213, 254, and the “⁺” operator is the element-wise addition function 214, as described above. The copy weight is generated from the last decoder layer output with the additional linear transformation and sigmoid layer 253, as described above.

### Procedural Overview-Training

FIG. 4 is a flowchart illustrating operation of a mechanism for training of a copy-or-generate model in accordance with an illustrative embodiment. Operation begins (block 400) for a copy-or-generate model to be trained using a training dataset including context data and corresponding target data representing outputs to be generated given the context data. The mechanism performs dataset pre-processing for training by performing context processing (block 401) and target processing (block 402). In practice, the mechanism does not feed the raw prompt and expected answers to the model for the training phase. Rather, the mechanism first applies a processing/compression phase. In the fully sandboxed decoding configuration, context processing generates a dual training dataset whose information is only recoverable with the use of compression lookup tables.

In the semi-sandboxed configuration, the mechanism creates additional elements derived from the context that are used to construct aggregated embeddings, which are a compressed representation of the original data, and builds aggregate embeddings (block 403). The embedding aggregation for the semi-sandboxed configuration can be customized to allow varying levels of information leaking, as will be described in further detail below with reference to FIG. 8. Building the aggregate embeddings is not performed for the fully sandboxed configuration.

The mechanism then creates a dataset for training the model (block 404) and trains the model using the dataset (block 405). Thereafter, operation ends (block 406).

### Data Pre-Processing Required for Training

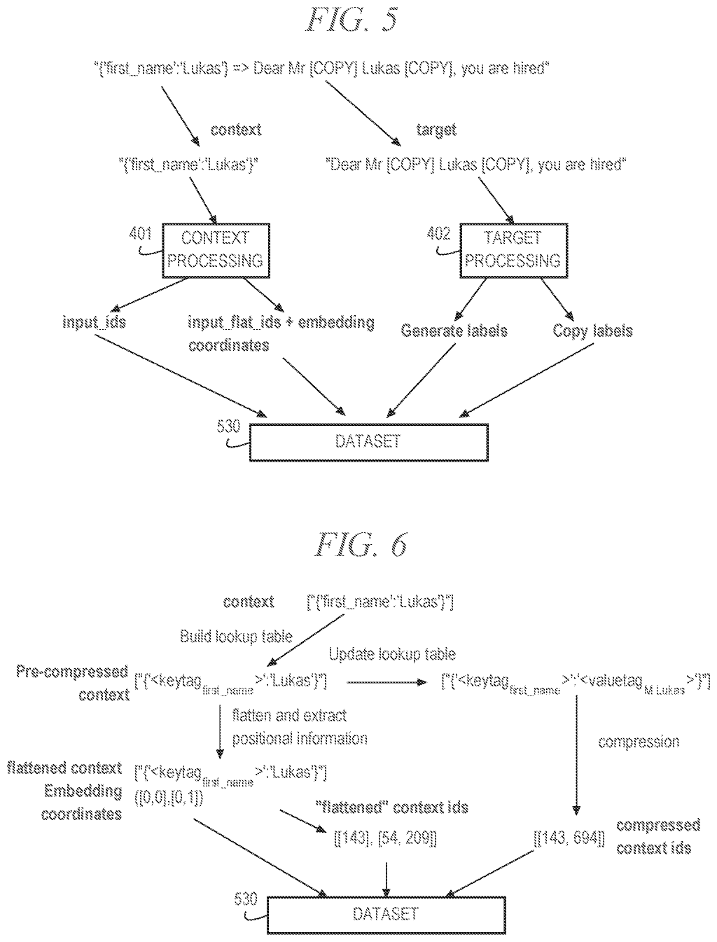

FIG. 5 illustrating creation and pre-processing of a training dataset in accordance with an illustrative embodiment. The dataset pre-processing includes performing context processing 401 and performing target processing 402, which will be described in further detail below. For each element in the raw dataset, the mechanism processes the context and the target separately and generates the elements to be used by the model during training. In the example shown in FIG. 5, the raw dataset includes a context of “{‘first_name’:‘Lukas’}” and a target of “Dear Mr [COPY] Lukas [COPY], you are hired.”

Context processing 401 generates input_ids and input_flat_ids and embedding coordinates. The input_ids are the processed/compressed encoded context to be used by copy decoder 250. The input_flat_ids and coordinates are the information used to build the aggregated embeddings. Thus, in the fully sandboxed configuration, the context processing 401 may generate only the input_ids, and the input_flat_ids and coordinates may be generated only in the semi-sandboxed configuration. Target processing 402 creates generate labels and copy labels. The generate labels are the expected answer associated with the context (prompt). The copy labels are binary values for each element in the labels to train the model to learn where to generate and where to copy. The input_ids, as well as input_flat_ids and coordinates (for semi-sandboxed configuration), generate labels, and copy labels are added to the dataset 530 to be used for training the model.

### Context Processing

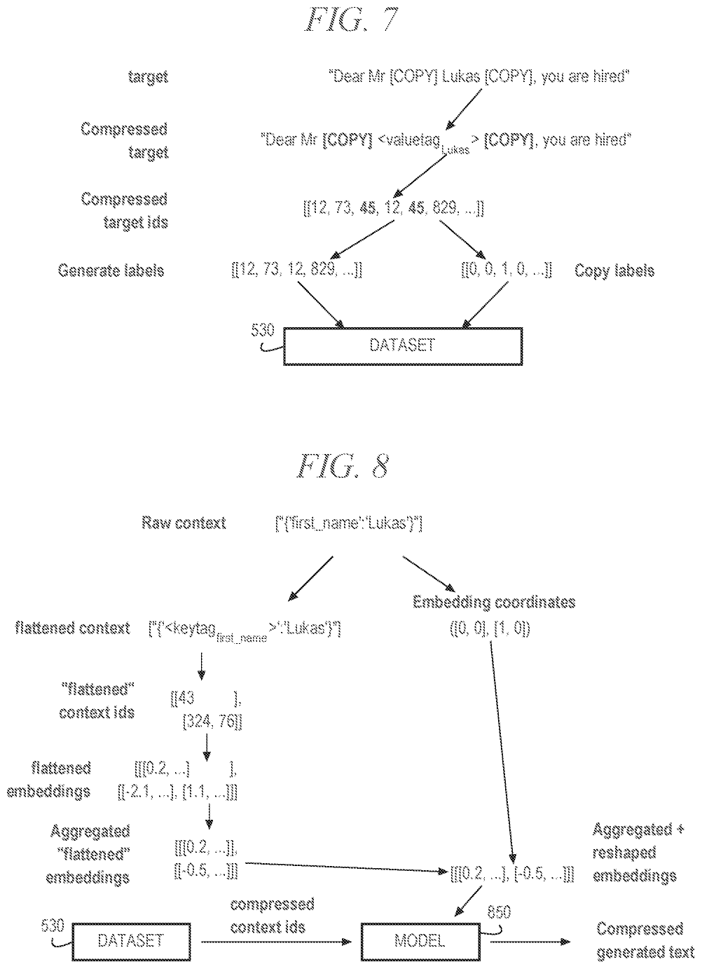

FIG. 6 illustrates context processing and compression in accordance with an illustrative embodiment. Performing context processing 401 creates a compressed and private context that will be used by the copy decoder and, for the semi-sandboxed configuration, additional elements derived from the context that will be used at training time to build the aggregated embeddings. The keys and values from the context are replaced by a key/value tag, such as [“{‘<keytag_{first_name}>’:‘Lukas’}”] in FIG. 6. These tags are single-token elements taken from the vocabulary. Either the least used tokens from the vocabulary are chosen or the vocabulary is extended with new tokens. The key/value tag mapping is stored in bidirectional lookup tables, which are not shared with the model. The resulting key/value tag mapping is shown as [“{‘<keytag_{first_name}>’:‘<valuetag_{M Lukas}>’}”] in FIG. 6. The tables are used once again for the sandboxed decoding after the generation of the output. With the fully sandboxed configuration, the model is fully blind to true original data, which prevents any data leaking caused by prompt injection techniques.

A “flattened” version of the context is created along with the original embedding coordinates of the elements, to be used for the embedding reconstruction. The flattened context ids and embedding coordinates are used to build the aggregate embeddings. In the example

shown in FIG. 6, the ‘<keytagfirst_name>’ tag has a context id of [143], and the name “Lukas” has the context ids [54, 209]. For example, the token “Lu” may have an id of 54, and the token “kas” may have an id of 209.

For the key/value tag mapping, the ‘<keytag_{first_name}>’ tag has a context id of [143], and the ‘<valuetag_{M Lukas}>’ tag has a context id of [694]. Thus, the compressed context ids are [[143, 694]]. Embeddings for the compressed context ids are what are provided to the model, thus keeping actual values in the context private. The bidirectional lookup tables are used to decompress the compressed context ids for tokens that are copied from the context. The embedding coordinates, flattened context ids, and compressed context ids are added to the dataset 530. In the depicted example, the name “Lukas” is prepended with the gender indicator “M” to assist in the conditional generate task.

In the depicted example, the embedding coordinates are “x/y” coordinates with the x coordinate corresponding to the position of the element in the batch, and the y coordinate corresponding to the position of the element in the sequence. In the example shown in FIG. 6, there is only one element in the batch (one context), so the x coordinates are [0, 0], and as there are two elements in the first context (one key and its corresponding value), the y coordinates are [0, 1]. In practice, there will likely be many contexts in the training dataset with multiple elements. For example, there may be a context element for the job position for which the candidate has applied. This would be reflected in the embedding coordinates.

### Target Processing

FIG. 7 illustrates target processing in accordance with an illustrative embodiment. The target processing consists of compressing the elements in the target and creating the copy labels. The elements in the target are compressed by using the lookup tables built when processing the contexts. To avoid compressing the wrong elements in the target sequence, only the sequences enclosed by copy tags are compressed. Once the copy tags are used to determine the position of elements to copy from the target, the copy tags are removed from the target.

First, the name “Lukas” is compressed to its compressed tag “<valuetag_{Lukas}>. Then, using the “[COPY]” tag, the position of elements to copy is determined. Here, the third element (“Lukas”) must be copied, and the rest must be generated. Similar to context processing, the labels and copy labels sent to the model do not hold any sensitive information. Instead, equivalent value tags are used.

The copy labels are used during the training phase only, the same way the generate labels are used. During inference, only the context ids are passed to the model (plus the aggregated embeddings when using the semi-sandboxed decoding). In FIG. 7, the word “Dear” has a compressed target id of [12], the word “Mr” has a compressed target id of [73], the copy tag has a compressed target id of [45], “<valuetag_{Lukas}>” has a compressed target id of [12], and so on. With the copy labels removed, the generate labels are [[12, 73, 12, 829, . . . ]], and the copy labels are [[0, 0, 1, 0, . . . ]] to indicate the third element is to be copied from the context. The generate labels and copy labels are added to dataset 530.

The training loss is simply the sum of the generation loss (from the averaged generation+copy distribution, negative log-likelihood loss) and the copy weight loss (binary cross entropy between the copy weight and the copy labels).

### Embedding Aggregation

FIG. 8 illustrates embedding aggregation in accordance with an illustrative embodiment. The key “first_name” is compressed, but the name “Lukas” is kept whole to preserve its meaning. The flattened context id for “<keytag_{first_name}>” is [43], the flattened context ids for “Lukas” are [324, 76]. After flattening the context, the embeddings are generated to form flattened embeddings. A word embedding represents a word as a real-valued vector that encodes the meaning of the word in such a way that words that are closer in the vector space are expected to be similar in meaning. The context id [43 ] results in the embedding [0.2, . . . ], the context id [324 ] results in the embedding [−2.1, . . . ], and the context id [76 ] results in the embedding [1.1, . . . ]. The flattened embeddings are then averaged to obtain the aggregated flattened embeddings. In FIG. 8, the average of [−2.1, . . . ] and [1.1, . . . ] is [−0.5, . . . ]. Thus, the aggregated “flattened” embeddings are [[[0.2, . . . ]], [[−0.5, . . . ]]]. The aggregated embeddings are then reshaped to the correct shape.

The amount of raw context information to be passed to the aggregated embeddings builder depends on the use case. In the example shown in FIG. 8, the names are used to infer gender from the aggregated embeddings and to generate either “Mr” for a male name or “Mrs” for a female name. If there exists a “homomorphic” equivalent relation with respect to the use case, using the raw context information can be avoided. For instance, replacing a male name by any other male name for the aggregated embedding, or replacing a female name with any other female name, would give the same output.

### Procedural Overview-Inference

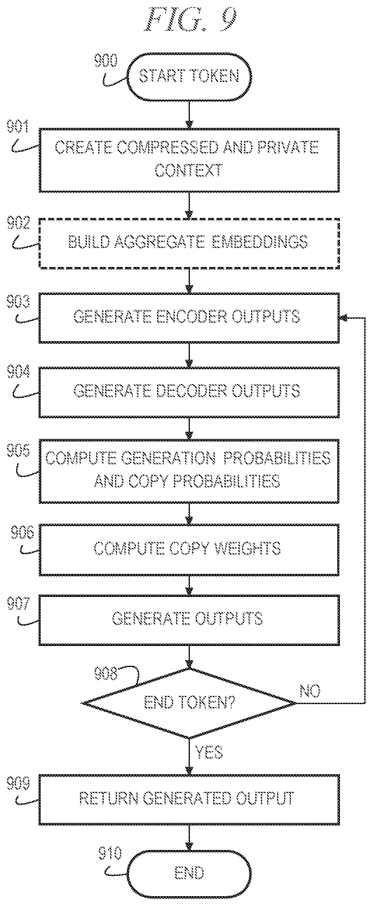

FIG. 9 is a flowchart illustrating inference using a copy-or-generate model in accordance with an illustrative embodiment. Operation begins with a start token indicating that there are no previous decoder outputs (block 900), and the model creates a compressed and private context (block 901) similar to the context processing described above for training with reference to FIGS. 5 and 6. For a semi-sandboxed configuration, the model builds aggregate embeddings for additional elements derived from the context (block 902) similar to the embedding aggregation described above for training with reference to FIG. 8. The model generates encode outputs (block 903) and generates decoder outputs (block 904). The model then computes generation probabilities and copy probabilities (block 905) and computes copy weights (block 906). The model generates outputs based on the generation probabilities, copy probabilities, and copy weights (block 907).

The model determines whether an end token is generated (block 908). An end token indicates that the model has completed text generation. If an end token has not been generated (block 908:NO), then operation returns to block 903 to generate the next token. If an end token has been generated (block 908:YES), then the model returns the generated output (block 909), and operation ends (block 910).

### Implementation Details

The following pseudocode portions use the Python programming language as a reference language. These pseudo code sections are for clarity purposes and do not correspond to an actual implementation of the illustrative embodiments. The actual code may vary depending on the implementation.

The following pseudocode presents a forward pass of the copy-or-generate model implementation corresponding to the model architecture shown in FIG. 2:

```
def copy_or_generate_forward(
      model,
      input_ids,
      input_embeddings,
      encoder_outputs,
      generation_labels,
      copy_labels):
  # 1. Generate the Encoder Outputs either using the inputs token ids or the
embeddings
  if encoder_outputs is None:
    encoder_outputs = model.encoder(
      input_ids=input_ids,
      input_embeddings=input_embeddings
    )
  # 2. Generate the Decoding outputs
  sequence_output, attention_scores = model.decoder(
    input_ids=shift_right(generation_labels),
    encoder_outputs=encoder_outputs
  )
  # 3. Compute the copy weights, the generation logits and the copy logits
  copy_weights = compute_copy_weights(sequence_output)
  generation_logits = compute_generation_logits(sequence_output)
  copy_logits = compute_copy_logits(input_ids, attention_scores)
  # 4. Compute the final logits as a weighted average
  logits = (1−copy_weights)*generation_logits+copy_weights*copy_logits
  # 5. Compute the joint loss
  loss = (negative_log_likelihood_loss(generation_logits,generation_labels) +
      binary_cross_entropy_loss(copy_logits,copy_labels))
  return logits, loss
def compute_copy_logits(self, context_ids, attention_scores):
  “““Computes the copy probabilities from the attention scores
  context_ids: Tensor of shape [B, S] # S = context sequence size
  attention_scores: Tensor of shape [B, T, S] # T = decoder input/target
  sequence size
  ”””
  batch_size, input_len, context_len = attention_scores.size( )
  ids0 = torch.arange(batch_size).repeat_interleave(input_len*context_len)
  ids1 =
torch.arange(input_len).repeat_interleave(context_len).repeat(batch_size)
  ids2 = context_ids.repeat_interleave(input_len,axis=0).flatten( )
  padded_scores = torch.sparse_coo_tensor(torch.stack((ids0,ids1,ids2)),
        attention_scores.flatten( ),
        size=(batch_size,input_len,self.vocab_size))
  return padded_scores # tensor of shape [B, T, V] # V = vocabulary size
```

As mentioned above, the copy weights are computed with a dense layer followed by a sigmoid activation. The above pseudocode also includes the implementation of computing the “copy logits” (probability distribution), which is not trivial and corresponds to generation of the copy distribution shown in FIG. 3. Because the “copy logits” tensor mostly consists of zeroes, a sparse tensor is used in the implementation.

The following pseudocode presents how the copy-or-generate dataset is created:

```
def create_dataset(data,
      batch_size: int=1,
      shuffle: bool=True):
  “““Creates a dataset with all the necessary information required to
  train the CopyOrGenerate model
  ”””
  contexts, targets = split_data(data)
  context_batches, target_batches = create_batch_indices(contexts,targets,
batch_size)
  dataset = [ ]
  lookup_tables = None
  for context,target in zip(context_batches,target_batches):
    # Context processing (see Fig 5 for visual explanation of what happens)
    input_ids, input_flat_ids, embedding_coords, lookup_tables =
process_contexts(context, lookup_tables)
    # Target processing (see Fig 6 for visual explanation of what happens)
    generate_labels, copy_labels, lookup_tables =
process_targets(target,lookup_tables)
    # Create the batch data with all the information
    batch_data = CopyDataBatch(input_ids,input_flat_ids, embedding_coords,
        generate_labels, copy_labels)
    dataset.append(batch_data)
  return dataset, lookup_tables
```

The context processing corresponds to what is described with reference to FIG. 6, and the target processing corresponds to what is described with reference to FIG. 7.

The following pseudocode presents how the trained model is used during inference:

```
def copy_or_generate_inference(
    model,
    tokenizer,
    prompt,
    lookup_tables):
  # 1. Tokenize the prompt (from natural language to tokens)
  context = tokenizer (prompt)
  # 2. Generate the inputs to be fed to the model
  input_ids, input_flat_ids, embedding_coords = process_contexts(context,
lookup_tables)
  # 2b. (optional) generate the aggregated embeddings
  input_embeddings = generate_aggregated_embeddings(model,input_flat_ids,
embedding_coords)
  # 3. Generate the outputs with the usual \grave{ }model.generate( ) \grave{ }
  response_ids = model.generate(input_ids,input_embeddings)
  # 4. Convert the tokenized/encoded answers back to natural language
  raw_response = tokenizer.decode(response_ids) # from tokens to NL
  response = postprocess_data(response, lookup_tables) # replace compressed
tokens with original text
  return response
def perform_custom_embedding(
      input_ids: torch.Tensor,
      embedding_layer,
      embedding_coords,
      ) -> torch.Tensor:
  ″″″Computes the aggregated embeddings from flattened inputs,
  then reconstruct the embeddings such that they have the same
  shape as if the original inputs were composed of single-token
  elements only.
  ″″″
  # 1. Compute embeddings
  embeddings = embedding_layer(input_ids)
  # 2. Compute average along dimension 1
  embeddings = average_along_dim(embeddings,dim=1)
  # 3. Convert back to original shape
  embeddings = reshape_tensor(embeddings, embedding_coords)
  return embeddings
```

Given an input prompt, the model processes the prompt as the context was processed when creating the training dataset. Then, the model computes the aggregated embeddings, if using the semi-sandboxed configuration, generates the compressed output with the copy-or-generate model, and then converts the output back to plain uncompressed text.

The above pseudocode also includes an implementation of embedding aggregation to clarify the process. In the “postprocess_data” function, the lookup tables are used, and the compressed tokens are replaced with their original text value.

### Evaluation of the Capabilities of the Model

To test the capabilities of the copy-or-generate model, the mode is tested on a synthetically generated dataset. Consider the following prompt template:
{‘first_name’:‘<name>’}
   And consider the following expected answers:
Dear Mr <male name>, you are hired
Dear Mrs <female name>, you are hired
   To have the model learn properly to infer the gender from the names, an additional pre-training phase is included, where the model is trained as a classifier. Here, instead a prefix is simply appended to the names (“M” for male names, “F” for female names), which makes the training faster.
Paul→M Paul
Julia→F Julia
   The model reaches 100% accuracy on test data with a 30 k parameters model (excluding embeddings), thus the copy-or-generate model is thousands if not million times smaller than the Lare Language Models used for text generation. Yet, the copy-or-generate model of the illustrative embodiments can still perform the non-trivial generalization when using multi-token values. When using the semi-sandboxed decoding capability, the model can also perfectly adapt the output based on the content of the input values, here the adaption being based on gender learned from first names.

In the examples given above, giving the prefix “M” or “F” to the model, as shown in FIG. 6, is sufficient to get the full adaptation capability, which allows for a fully sandboxed text generation. Embedding aggregation, as detailed above, passes an amount of raw context information, thus exposing some amount of context information to leakage; however, compression, flattening, and embedding limits the exposure of the additional elements in the aggregated embeddings.

### Hardware Overview

According to one embodiment, the techniques described herein are implemented by one or more special-purpose computing devices. The special-purpose computing devices may be hard-wired to perform the techniques or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

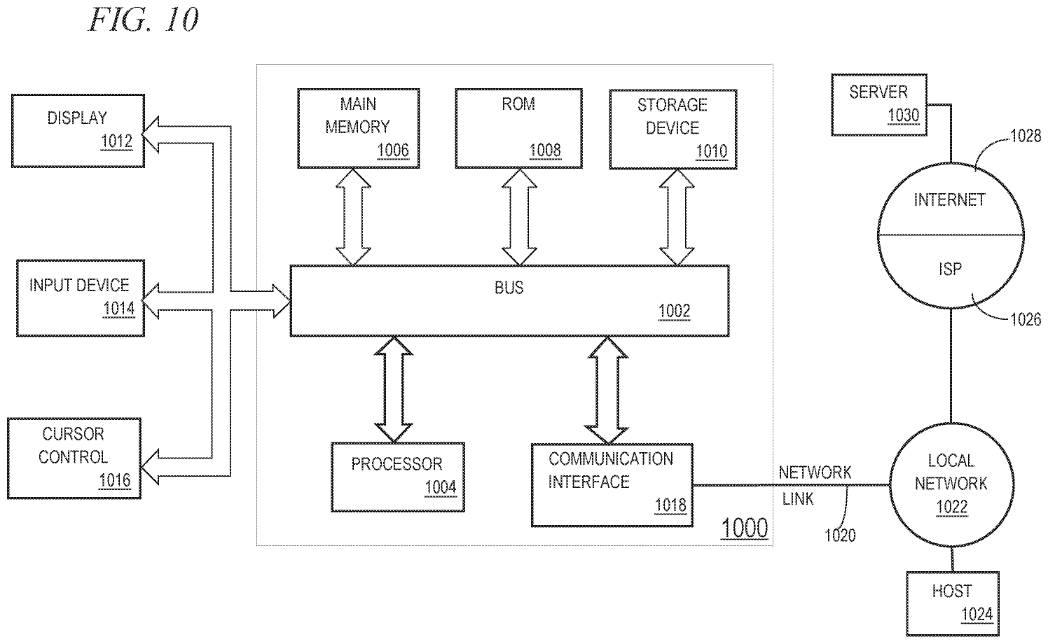

For example, FIG. 10 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general-purpose microprocessor.

Computer system 1000 also includes a main memory 1006, such as a random-access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk, optical disk, or solid-state drive is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 1010. Volatile media includes dynamic memory, such as main memory 1006. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid-state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic, or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world-wide packet data communication network now commonly referred to as the “Internet” 1028. Local network 1022 and Internet 1028 both use electrical, electromagnetic, or optical signals that carry digital data streams. The signals through the various networks and the signals on network link 1020 and through communication interface 1018, which carry the digital data to and from computer system 1000, are example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

### Software Overview

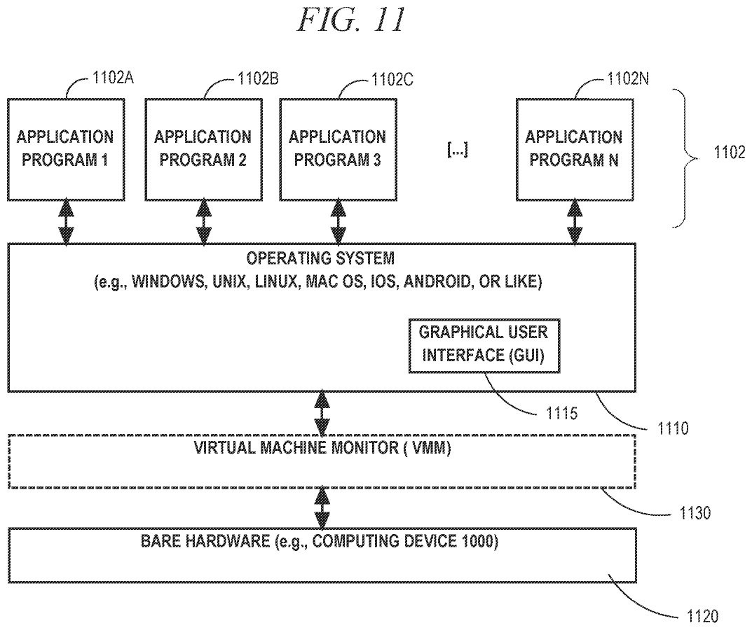

FIG. 11 is a block diagram of a basic software system 1100 that may be employed for controlling the operation of computer system 1100. Software system 1100 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 1100 is provided for directing the operation of computer system 1000. Software system 1100, which may be stored in system memory (RAM) 1006 and on fixed storage (e.g., hard disk or flash memory) 1010, includes a kernel or operating system (OS) 1110.

The OS 1110 manages low-level aspects of computer operation, including managing execution of processes, memory allocation, file input and output (I/O), and device I/O. One or more application programs, represented as 1102A, 1102B, 1102C . . . 1102N, may be “loaded” (e.g., transferred from fixed storage 1010 into memory 1006) for execution by the system 1100. The applications or other software intended for use on computer system 1000 may also be stored as a set of downloadable computer-executable instructions, for example, for downloading and installation from an Internet location (e.g., a Web server, an app store, or other online service).

Software system 1100 includes a graphical user interface (GUI) 1115, for receiving user commands and data in a graphical (e.g., “point-and-click” or “touch gesture”) fashion. These inputs, in turn, may be acted upon by the system 1100 in accordance with instructions from operating system 1110 and/or application(s) 1102. The GUI 1115 also serves to display the results of operation from the OS 1110 and application(s) 1102, whereupon the user may supply additional inputs or terminate the session (e.g., log off).

OS 1110 can execute directly on the bare hardware 1120 (e.g., processor(s) 1004) of computer system 1000. Alternatively, a hypervisor or virtual machine monitor (VMM) 1130 may be interposed between the bare hardware 1120 and the OS 1110. In this configuration, VMM 1130 acts as a software “cushion” or virtualization layer between the OS 1110 and the bare hardware 1120 of the computer system 1000.

VMM 1130 instantiates and runs one or more virtual machine instances (“guest machines”). Each guest machine comprises a “guest” operating system, such as OS 1110, and one or more applications, such as application(s) 1102, designed to execute on the guest operating system. The VMM 1130 presents the guest operating systems with a virtual operating platform and manages the execution of the guest operating systems.

In some instances, the VMM 1130 may allow a guest operating system to run as if it is running on the bare hardware 1120 of computer system 1000 directly. In these instances, the same version of the guest operating system configured to execute on the bare hardware 1120 directly may also execute on VMM 1130 without modification or reconfiguration. In other words, VMM 1130 may provide full hardware and CPU virtualization to a guest operating system in some instances.

In other instances, a guest operating system may be specially designed or configured to execute on VMM 1130 for efficiency. In these instances, the guest operating system is “aware” that it executes on a virtual machine monitor. In other words, VMM 1130 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g., content of registers) between allotments of the hardware processor time when the computer system process is not running. Computer system processes run under the control of an operating system and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an laaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
generating a text output based on an input context using a machine learning model,
wherein the input context comprises a set of one or more context elements,
wherein generating the text output comprises:
generating a set of next tokens for the text output;
generating a generation distribution that represents, for each generated token in the set of next tokens, a probability the generated token is to be added to the text output;
generating a copy distribution that represents, for each context element in the input context, a probability the context element is to be copied to the text output; and
determining, based on a copy weight, whether to (a) use the generation distribution to add a generated token from the set of next tokens to the text output or (b) use the copy distribution to copy a context element from the input context to the text output, and
wherein the method is performed by one or more computing devices.

2. The method of claim 1, wherein the machine learning model is a transformer model comprising one or more encoder layers and one or more decoder layers.

3. The method of claim 2, wherein the copy distribution is generated from cross-attention scores generated by the one or more decoder layers.

4. The method of claim 2, wherein the copy weight is generated from a last decoder layer output using a linear and sigmoid layer.

5. The method of claim 2, wherein the transformer model further comprises a copy decoder that generates the copy distribution and the copy weight.

6. The method of claim 1, further comprising copying a given context element to the text output directly from the input context based on a set of coordinates indicating a position of the given context element in the input context.

7. The method of claim 1, further comprising:
performing context processing and target processing on a training dataset to form a processed training dataset, wherein the training dataset comprises a set of training contexts and a corresponding set of targets; and
training the machine learning model based on the processed training dataset to generate a text output.

8. The method of claim 7, wherein:
each training context comprises a set of key-value pairs,
performing context processing comprises replacing each key-value pair in the set of key-value pairs with a key-value tag and storing a mapping of key-value pairs to key-value tags in a bidirectional lookup table,
a particular target includes a copy tag indicating that a particular element from a particular training context is to be copied into an output of the machine learning model,
performing target processing comprises compressing elements in each target using the bidirectional lookup table, determining a position of the particular element in the particular training context, and removing the copy tag from the target.

9. The method of claim 8, wherein the key-value tag does not reveal the value in the key-value pair to the machine learning model.

10. The method of claim 8, wherein:
performing context processing further comprises building aggregate embeddings by:
generating a set of one or more embeddings for each value of each key-value pair in the set of key-value pairs, and
aggregating the one or more embeddings to form an aggregated embedding for each key-value pair.

11. The method of claim 10, wherein aggregating the one or more embeddings comprises averaging the one or more embeddings.

12. The method of claim 10, wherein the aggregated embeddings expose a portion of context information to the machine learning model.

13. One or more non-transitory storage media storing instructions which, when executed by one or more computing devices, cause:
generating a text output based on an input context using a machine learning model,
wherein the input context comprises a set of one or more context elements, and
wherein generating the text output comprises:
generating a set of next tokens for the text output;
generating a generation distribution that represents, for each generated token in the set of next tokens, a probability the generated token is to be added to the text output;
generating a copy distribution that represents, for each context element in the input context, a probability the context element is to be copied to the text output; and
determining, based on a copy weight, whether to (a) use the generation distribution to add a generated token from the set of next tokens to the text output or (b) use the copy distribution to copy a context element from the input context to the text output.

14. The one or more non-transitory storage media of claim 13, wherein the machine learning model is a transformer model comprising one or more encoder layers and one or more decoder layers.

15. The one or more non-transitory storage media of claim 14, wherein the transformer model further comprises a copy decoder that generates the copy distribution and the copy weight.

16. The one or more non-transitory storage media of claim 13, wherein the instructions further cause copying a given context element to the text output directly from the input context based on a set of coordinates indicating a position of the given context element in the input context.

17. The one or more non-transitory storage media of claim 13, wherein the instructions further cause:
performing context processing and target processing on a training dataset to form a processed training dataset, wherein the training dataset comprises a set of training contexts and a corresponding set of targets; and
training the machine learning model based on the processed training dataset to generate a text output.

18. The one or more non-transitory storage media of claim 17, wherein:
each training context comprises a set of key-value pairs,
performing context processing comprises replacing each key-value pair in the set of key-value pairs with a key-value tag and storing a mapping of key-value pairs to key-value tags in a bidirectional lookup table,
a particular target includes a copy tag indicating that a particular element from a particular training context is to be copied into an output of the machine learning model,
performing target processing comprises compressing elements in each target using the bidirectional lookup table, determining a position of the particular element in the particular training context, and removing the copy tag from the target.

19. The one or more non-transitory storage media of claim 18, wherein the key-value tag does not reveal the value in the key-value pair to the machine learning model.

20. The one or more non-transitory storage media of claim 18, wherein:
performing context processing further comprises building aggregate embeddings by:
generating a set of one or more embeddings for each value of each key-value pair in the set of key-value pairs, and
aggregating the one or more embeddings to form an aggregated embedding for each key-value pair.
